(19) United States
(12) Patent Application Publication
(10) Pub. No.: US 2022/0335719 A1
(43) Pub. Date: Oct. 20, 2022

(54) IMPLEMENTING MOMENTS DETECTED FROM VIDEO AND AUDIO DATA ANALYSIS

(71) Applicant: Watch Fantom Inc. d.b.a. CatapultX, Montclair, NJ (US)

(72) Inventors: James Altschuler, Brooklyn, NY (US); James Tammaro, Bedford, NH (US); Zack Rosenberg, Montclair, NJ (US); Kuan-Chuen Wu, Ames, IA (US)

(21) Appl. No.: 17/721,446

(22) Filed: Apr. 15, 2022

Related U.S. Application Data
(60) Provisional application No. 63/175,710, filed on Apr. 16, 2021.

(51) Int. Cl. G06V 20/40; G06V 10/20; G06V 10/82; G06V 10/96; G10L 25/57; G10L 25/30

(52) U.S. Cl. CPC G06V 20/41; G06V 10/20; G06V 10/82; G06V 10/96; G10L 25/57; G10L 25/30

(57) ABSTRACT

A method includes obtaining, by a processing device, source content, wherein the source content includes at least one of visual content or audio content, preprocessing, by the processing device, the source content to obtain preprocessed source content, identifying, by the processing device using machine learning, a set of concepts based on the preprocessed source content, wherein each concept of the set of concepts is identified for a respective unit of the source content, and detecting, by the processing device, a set of moments in the source content, wherein each moment of the set of moments corresponds to a respective grouping of concepts of the set of concepts, wherein each moment of the set of moments is associated with one or more attributes that describe the moment within the source content, and wherein each moment of the set of moments is associated with one or more categories.

### RELATED APPLICATION

This application claims the benefit of U.S. Provisional Application No. 63/175,710, filed Apr. 16, 2021 and entitled “Displaying and Rendering Contextual Sub-Content based on Video Analysis,” the entire contents of which are hereby incorporated by reference herein.

### TECHNICAL FIELD

The embodiments described herein generally relate to artificial intelligence and machine learning, and more particularly relate to implementing moments detected from video and audio data analysis.

### BACKGROUND

Artificial intelligence and/or machine learning technology can be used to identify information within content (e.g., image content, audio content and/or or text content). For example, using computer vision and image recognition technologies, computational analyses can be performed on an image to identify one or more objects within an image. Additionally or alternatively, audio can be converted to text and natural language processing (NLP) technologies can be performed on text to identify one or more words (e.g., keywords) within the text. Additionally or alternatively, digital audio signal processing can be performed to identify one or more characteristics of sound within audio content.

### SUMMARY

In one implementation, disclosed is a method. The method includes obtaining, by a processing device, source content, wherein the source content includes at least one of visual content or audio content, preprocessing, by the processing device, the source content to obtain preprocessed source content, identifying, by the processing device using machine learning, a set of concepts based on the preprocessed source content, wherein each concept of the set of concepts is identified for a respective unit of the source content, and detecting, by the processing device, a set of moments in the source content, wherein each moment of the set of moments corresponds to a respective grouping of concepts of the set of concepts, wherein each moment of the set of moments is associated with one or more attributes that describe the moment within the source content, and wherein each moment of the set of moments is associated with one or more categories.

In another implementation, disclosed is a system. The system includes a memory device, and a processing device, operatively coupled to the memory device, to perform operations including obtaining source content, wherein the source content includes at least one of visual content or audio content, preprocessing the source content to obtain preprocessed source content, identifying, using machine learning, a set of concepts based on the preprocessed source content, wherein each concept of the set of concepts is identified for a respective unit of the source content, and detecting a set of moments in the source content, wherein each moment of the set of moments corresponds to a respective grouping of concepts of the set of concepts, wherein each moment of the set of moments is associated with one or more attributes that describe the moment within the source content, and wherein each moment of the set of moments is associated with one or more categories.

In yet another implementation, disclosed is a non-transitory machine-readable storage medium. The non-transitory computer-readable storage medium stores instructions that, when executed by a processing device, cause the processing device to perform operations including obtaining source content, wherein the source content includes at least one of visual content or audio content, preprocessing the source content to obtain preprocessed source content, identifying, using machine learning, a set of concepts based on the preprocessed source content, wherein each concept of the set of concepts is identified for a respective unit of the source content, and detecting a set of moments in the source content, wherein each moment of the set of moments corresponds to a respective grouping of concepts of the set of concepts, wherein each moment of the set of moments is associated with one or more attributes that describe the moment within the source content, and wherein each moment of the set of moments is associated with one or more categories.

### BRIEF DESCRIPTION OF THE DRAWINGS

The disclosure is illustrated by way of examples, and not by way of limitation, and may be more fully understood with references to the following detailed description when considered in connection with the figures, in which:

FIGS. 1A-1B depict block diagrams of an example computer system, in accordance with some embodiments.

FIGS. 2A-2E depict block diagrams of an example system for implementing moments identified from video and audio data analysis, in accordance with some embodiments.

FIG. 3 depicts a block/flow diagram of an example system for implementing moments identified from source content, in accordance with some embodiments.

FIG. 4 depicts a block/flow diagram of a system architecture, in accordance with some embodiments.

FIG. 5 depicts a flow diagram of an example method for implementing moments identified from source content, in accordance with some embodiments.

FIG. 6 depicts a block diagram of an illustrative computing device operating in accordance with the examples of the disclosure.

### DETAILED DESCRIPTION

Described herein are systems and methods to implement moments detected from video and audio data analysis. A video can include a combination of visual content and/or audio content (e.g., audiovisual content). For example, a video can include a number of frames of images (“frames”). A video can depict a number of different scenes, where each scene characterizes a section of the video including a set of contiguous frames (e.g., a set of shots) taken over a continuous time interval from a particular location. A scene can depict a number of actions, a number of objects, a number of actions, text, etc. A scene can further include respective audio content (e.g., dialogue, music).

Embodiments described herein can utilize artificial intelligence and machine learning techniques to detect and evaluate moments within source content, and implement the moments to perform one or more actions. The source content can include video data and/or audio data (e.g., audiovisual data). For example, the source content can include at least one of: a recorded video (e.g., movie or television show), a live video (e.g., a live television show), streaming video, a non-streaming video, live or recorded audio recording (e.g., a song, podcast), etc.

The moment detection process can include identifying concepts within the source content, and classifying the concepts. For example, identifying concepts within the source content can include decomposing the source content into a number of units, and identifying a respective concept for each unit. A unit of source content refers to a minimum amount of data within the source content from which a meaning can be derived using one or more suitable machine learning techniques (e.g., computer vision, digital audio signal processing, semantic analysis). For example, a unit of source content can be a visual unit or an audio unit. A visual unit can be a frame including one or more objects, a sequence of frames depicting one or more actions, a minimum amount of text that conveys meaning (e.g., phrase, sentence, question), etc. An audio unit can be a minimum amount of audio (e.g., speech, sounds or words) that conveys meaning. For example, if a frame of source content includes an image of a dog, then the frame can be classified as at least one of “dog”, “animal”, etc. As another example, if characters within a scene are discussing taking a trip to Europe, then the audio can be classified as at least one of “travel”, “Europe”, etc. As yet another example, if there is a music in the content, then the music can be used to classify mood (e.g., happy, sad, scary). As yet another example, if there are birds “chirping” in the content, the audio can be used to identify at least one of “animal”, “bird”, etc.

Concepts can be identified and classified using artificial intelligence machine learning techniques. For example, concept identification and classification can include performing at least one of: object recognition to identify one or more objects within each frame of the source content, action recognition to identify one or more actions within each sequence of frames of the source content, natural language processing (NLP) to identify one or more keyword/concept units within the source content, digital audio signal processing to identify one or more characteristics of sound within audio content, or speech recognition to convert audio (e.g., voices) to text. Further details regarding concept identification and classification, including object recognition, action recognition, NLP, digital audio signal processing and speech recognition are described below herein.

The source content can be preprocessed to enable and/or improve the concept identification and classification. The source content can be preprocessed using artificial intelligence and machine learning techniques. For example, preprocessing the source content can include performing at least one of: smoothing, sharpening, edge detection, scene detection, image segmentation, audio transcription, virality identification, or provider agnostic content identification. Further details regarding source content preprocessing are described below herein.

A set of moments can be detected from the concepts. Each moment can refer to a segment of the source content defined by a respective grouping of concepts based on the classification. For example, a number of different clustering techniques can be applied to the concepts to generate the set of moments. Each moment can be categorized into one or more categories. For example, the one or more categories can include a genre category. As another example, the one or more categories can include an industry-standard category. Examples of industry standard categories include, e.g., Interactive Advertising Bureau (IAB) categories and Global Alliance for Responsible Media (GARM) categories.

Embodiments described herein can further evaluate a moment detected within the source content. For example, the mapping to the one or more categories can enable each moment to be evaluated by its contextuality and/or industry use, which can be used in the various moment implementations described below. Evaluating a moment can include determining the value of the moment for a particular use case or implementation, as will be described in further detail below.

Embodiments described herein can implement moments with respect to a number of potential use cases. One type of use case is content cataloging in which moments are used to catalog content in view of genre categorizations.

Another type of use case is contextual sub-content targeting. Contextual sub-content refers to digital content that is identified as being relevant to a particular moment within a video. One implementation of contextual sub-content targeting is integrating contextual sub-content within content to be consumed by one or more users (e.g., video and/or audio content). For example, the contextual sub-content can be provided by a contextual sub-content server. In some embodiments, the contextual sub-content is digital advertising content to be presented during consumption of the content. Integrating the contextual sub-content within the content can include at least one of displaying the contextual sub-content by overlaying the contextual sub-content over the content during content playback (e.g., on stream during playback), rendering the contextual sub-content into the content (e.g., including the contextual sub-content within the content file itself), or inserting (e.g., stitching) the contextual sub-content into the content within the same stream (e.g., server side digital advertisement (“ad”) insertion (SSAI)). Other implementations of contextual sub-content targeting include, for example: (1) companion targeting (e.g., if the contextual sub-content is a digital advertisement, pairing the contextual sub-content with traditional forms of video advertising such as pre-roll and mid roll); (2) media syndication in which advertisers can extend their reach; (3) media planning (e.g., influencing digital advertisements provided to users via a web page, application, etc., understanding the moments that perform best for advertisers to dictate digital advertisements that will perform better, such as high performance next to cat content would suggest using cats in a digital advertisement); (4) trend identification around moments within content; (5) researching which categories of products perform better for certain moments than others; (6) understanding which moments perform best for particular advertising campaigns and help them choose, forecast, plan, and buy digital advertisements against these moments; and/or (7) using audience interest data of moments to better target digital advertising campaigns.

Another type of use case is moment safety in which moment categorization (e.g., GARM categorization) is used to determine whether a moment is harmful. For example, in digital advertising, moment safety can be viewed as brand safety for a particular brand. For example, if a moment is classified as being overly violent, then that moment may not be of value to a children's toy brand who would like to integrate a digital advertisement for a children's toy within content.

Applying machine learning techniques to source content, and particularly live or streaming video, is a particularly challenging technological problem that has not been adequately solved, due to complexities such as dropped frames, incomplete frames, lossy or noisy data transmission, and processing speed requirements for performing machine learning tasks in real-time. Embodiments described herein can address at least some of these issues by implementing a number of specialized neural networks and/or evolutionary algorithms (e.g., genetic algorithms, evolutionary programming algorithms, and/or swarm algorithms) that are tailored or targeted for one or more specific purposes, such as a particular recognition task (e.g., object recognition). Each specialized neural network can be referred to as a “Nano Neural Network” (NNN). Each NNN is individually trained and tested to perform a specialized machine learning task within the system (e.g., object recognition, action recognition). For example, one NNN can be trained to recognize a certain celebrity's face from various viewpoints or angles, another NNN can be trained to identify a certain brand of automobile, etc. Each NNN can perform its specialized machine learning task in parallel using parallel processing to optimize processing resources (e.g., CPU and/or GPU resources).

Embodiments described herein can empirically optimize, on a continuous basis, the structural topology of NNN's in terms of a set of criteria. For example, the set of criteria can include task completion accuracy, task completion speed, etc. Embodiments described herein can use information derived from the source content to select, deploy and/or orchestrate the highest performing NNN's in accordance with their designated specialized machine learning tasks. Each NNN can be trained to learn its respective specialized machine learning task using training data relevant to the specialized machine learning task. Each NNN can be tested to validate the performance of the NNN using testing data. Testing data can be data that is relevant to the specialized machine learning task, but different from the training data. The testing can further generate performance metrics, such as specialized machine learning task accuracy percentage or rating, specialized machine learning task time or speed rating, number of compute cycles, structural complexity, etc.

It may be the case that source content is not sufficiently popular or “viral” to justify the costs of processing the source content to perform moment detection. To reduce computational resource consumption, embodiments described herein can further implement a virality algorithm to evaluate whether there is a need to perform such computationally intensive analysis on a source content to reduce processing time and cost. If a threshold level is exceeded, or if a potential virality behavior is detected, then further analysis can be performed on the source content in order to perform moment detection and evaluation (e.g., concept identification and classification). Otherwise, such further analysis can be bypassed. For example, the virality algorithm can be implemented during source content preprocessing.

The virality algorithm can be implemented using a variety of suitable methods. One method for implementing the virality algorithm is by applying error-minimizing fitting to parametric families of curves that are generally considered to represent “viral” growth. Such curves can include, for example, exponential growth curves (with base strictly exceeding 1 and positive exponent), super-linear polynomial curves (with degree strictly exceeding 1), certain classes and/or subspaces of Non-Uniform Rational B-Splines (“NURBS”), etc.

Another method for implementing the virality algorithm is by generating a data structure using Bayesian machine learning of the source content's connectivity embedding. For example, the data structure can be a network graph.

Another method for implementing the virality algorithm is by employing an anomaly detection method. One example of an anomaly detection method is a neural network (e.g., recurrent neural network (RNN)) trained on non-viral video view data. This anomaly detection method can estimate the likelihood that an observation point comes from the RNN's training model, where a lower probability indicates more likely virality. Another example of an anomaly detection method is a neural network (e.g., RNN) trained on viral video view data. This anomaly detection method can estimate the likelihood that an observation point comes from the RNN's training model, where a lower probability indicates more likely non-virality.

Other methods for implementing the virality algorithm include, for example, implementing a variational autoencoder with long short-term memory (LSTM) to forecast a time series of video views, implementing (Hidden) Markov modeling of a video's view history with respect to time, implementing a random forest or gradient-boosted ensemble decision model with one or more of the preceding methods as decision trees, etc.

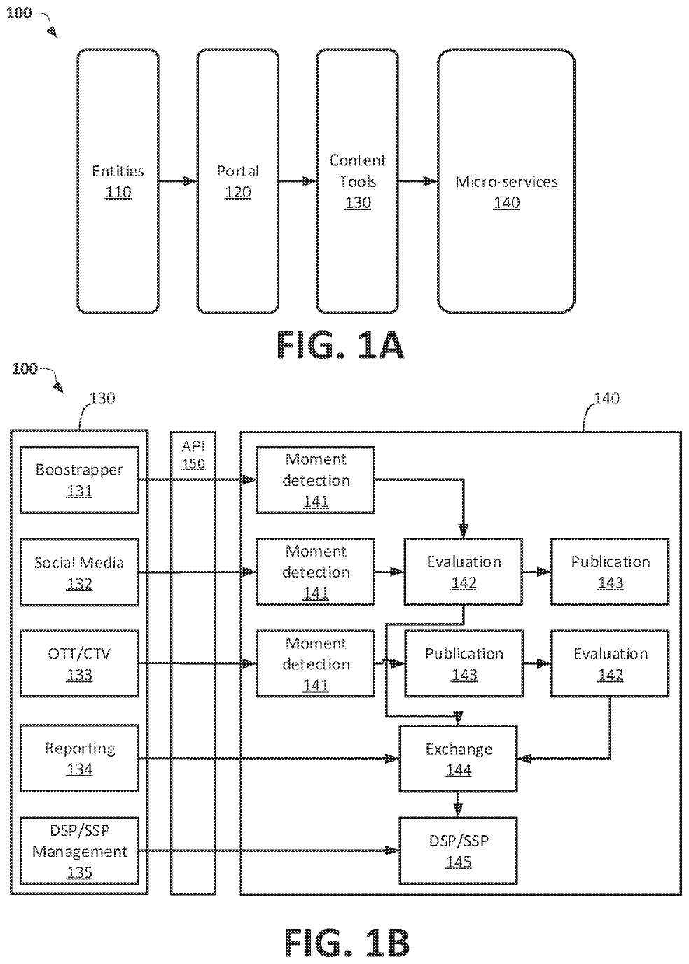

FIG. 1A is a diagram of an example computer system (“system”) 100, in accordance with some embodiments. As shown, the system 100 includes a set of entities 110, a portal 120, a set of content tools 130 and a micro-service system 140.

Each entity of the set of entities 110 can be a computing device or platform that can access a portal 120. Each entity of the set of entities 110 can be associated with at least one of: a publisher (“publisher”) or an advertiser. Publishers and/or advertisers can publish and/or monetize contextual sub-content integrated with content. As will be described in further detail herein, the content can include audio content and/or visual content (e.g., audiovisual content), and the contextual sub-content can be audio content and/or visual content (e.g., audiovisual content) derived from, and integrated within, the content. Visual content can be an image, video, text, etc. For example, the content can be a video and/or audio file or stream, and the contextual sub-content can be integrated into the video and/or audio file or stream (e.g., displayed on top of, rendered within and/or stitched within). In some embodiments, the contextual sub-content is advertising content.

The portal 120 can be used by the set of entities to access a set of content tools 130. The set of content tools 130 can include one or more tools to assist in the ability of an entity to publish and/or monetize content and/or contextual sub-content. For example, as shown, the set of content tools 130 can be used to access the micro-service system 140. Further details regarding the set of content tools 130 and the micro-service system 140 will now be described below with reference to FIG. 1B.

FIG. 1B is a diagram of the system 100 including the set of content tools 130 and the micro-service system 140. As further shown, the system 100 includes an application programming interface (API) 150. The API 150 can serve as a gateway for enabling communication between the set of content tools 130 and various components of the micro-service system 140.

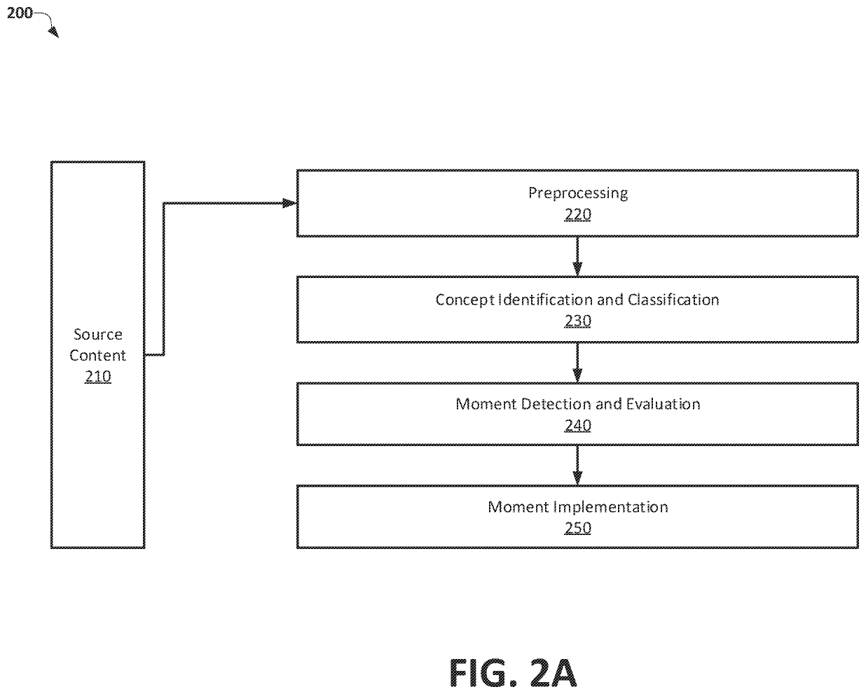

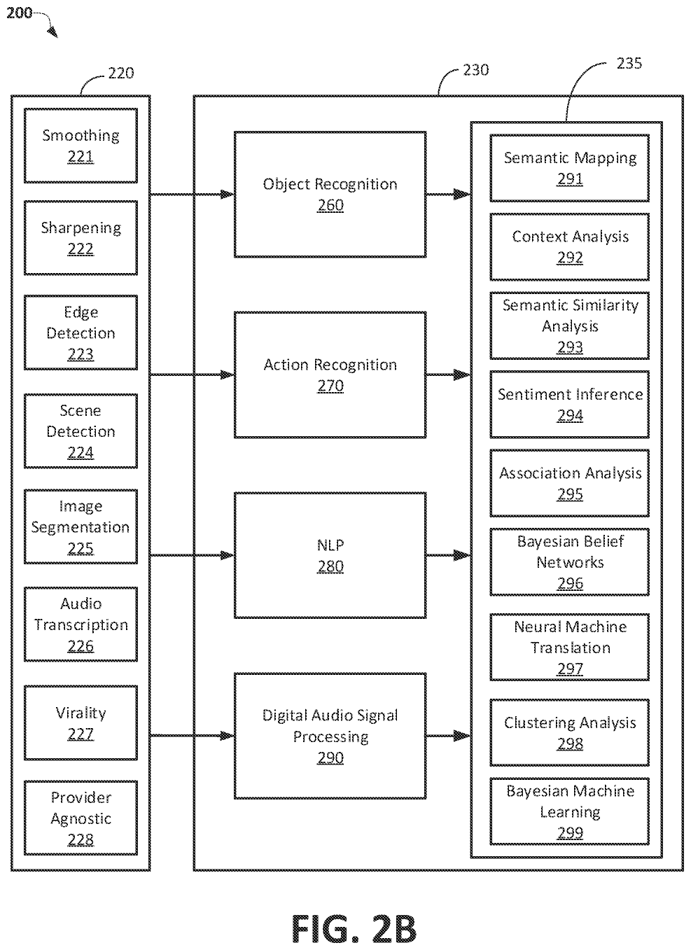

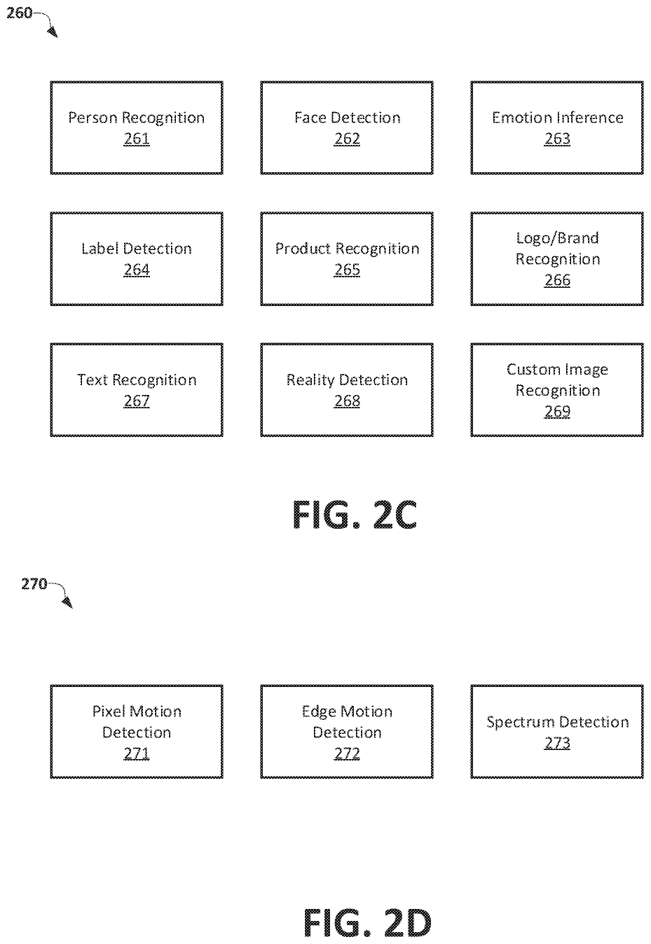

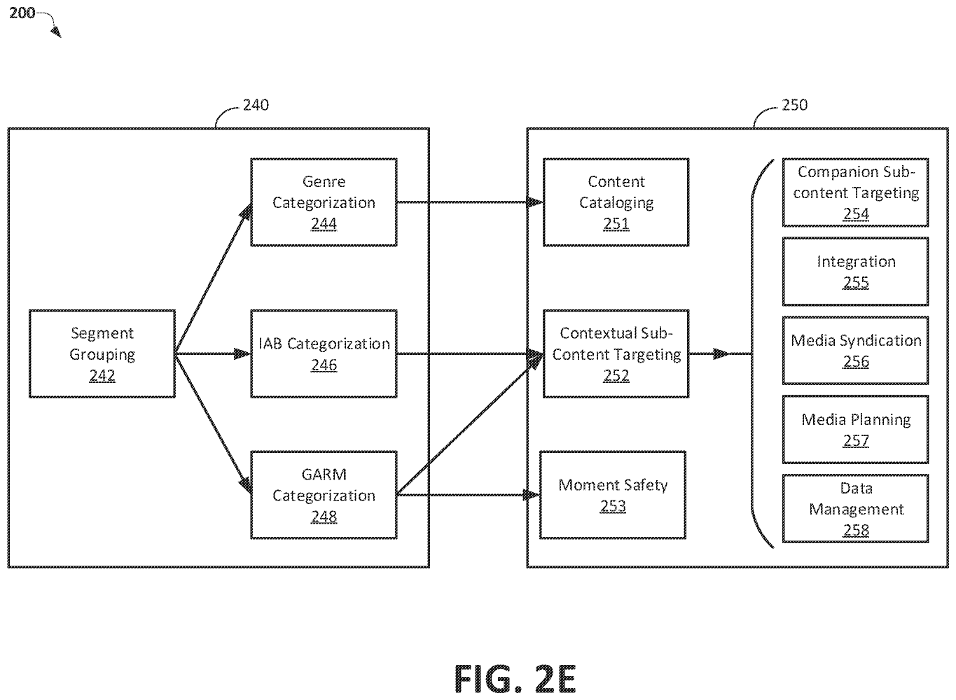

The micro-service system 140 can include a moment detection micro-service 141 to identify at least one moment from content (e.g., video and/or audio content), and an evaluation micro-service 142 to evaluate at least one of the content or the at least one moment. As will be described in further detail with reference to FIG. 2, the at least one moment can be identified using the moment detection micro-service 141 based on a set of attributes detected within the content. The set of attributes can include at least one of: speech, sounds, transcript, labels, objects, persons, and/or logos. The set of attributes can be analyzed using machine learning techniques to identify a set of features describing a moment. For example, the set of features can include at least one of: a concept, keyword and/or category.

The micro-service system 140 can further include a publication micro-service 143 to publish content to one or more platforms (e.g., website, social media), a contextual sub-content exchange server (“exchange”) 144, and at least one demand-side platform (DSP) and/or at least one supply-side platform (SSP) 145. In some embodiments, the exchange 144 is an advertisement (“ad”) server. The exchange 144 maintains the accounts and connections for publishers, remote DSP feeds, and direct advertisers. Using open real-time bidding (ORTB) standards, the exchange 144 can be called to begin an electronic auction based on a moment identified in the content. The set of features described above can be used by the exchange 144 to match the most relevant demand. A DSP/SSP is an automated platform for obtaining (e.g., purchasing) digital inventory. For example, the DSP/SSP 145 can include at least one of a direct DSP/SSP or a remote DSP/SSP. Based on what is configured in the exchange 144, demand is requested using ORTB standards and a bid response reflecting the bid information of entities (e.g., potential digital advertisement buyers) can be returned.

As shown, the set of content tools 130 can include a bootstrapper 131. The bootstrapper 131 is a tool that can place tags (e.g., bidder tags) on a content provider's property (e.g., publisher's website, mobile application and/or connected television (CTV) application or channel. When source content is received (e.g., a video/audio file), the source content can be passed to the moment detection micro-service 141 to detect at least one moment from the source content. The at least one moment can be evaluated by the evaluation micro-service 142, and calls can be made to the server 144 on every view to get demand based on source content context. The tags can also be used to display contextual sub-content over content while the content is in view (e.g., display contextual sub-content on the stream of content, or “on-stream”).

Additionally or alternatively, the set of tools 130 can include a social media tool 132. Similar to the bootstrapper 131, when source content is received, the source content can be passed to the moment detection micro-service 141 to identify at least one moment from the source content, the at least one moment can be evaluated by the evaluation micro-service 142, and calls can be made to the server 144 on every view to get demand based on source content context. Contextual sub-content can then be rendered or inserted (e.g., stitched) into content, and the publication micro-service 143 can publish the content with the rendered or inserted contextual sub-content to at least one social media platform.

Additionally or alternatively, the set of tools 130 can further include an over-the-top/connected television (OTT/CTV) tool 133. The OTT/CTV tool 133 can be used by an entity (e.g., OTT/CTV entity) to link its content for analysis prior to making the content available to their customers.

Additionally or alternatively, the set of tools 130 can further include a reporting tool 134. The reporting tool 134 can generate and/or provide a suite of reporting that includes video/audio analytic information, impressions revenue, cost data, etc.

Additionally or alternatively, the set of tools 130 can further include a DSP/SSP management tool 135. The DSP/SSP management tool 135 can utilize the at least one DSP/SSP 145. For example, the DSP/SSP management tool 135 can be used by at least one entity (e.g., publisher and/or advertiser) to manage an advertising campaign using the at least one DSP/SSP 145.

FIGS. 2A-2F depict diagrams of a system 200 for identifying and implementing moments, in accordance with some embodiments. The system 200 can include source content 210, a source content preprocessing (“preprocessing”) component 220, a concept identification and classification (“concept”) component 230, a moment detection and evaluation component (“moment component”) 240, and a moment implementation component 250.

Source content 210 is received by the preprocessing component 220 to preprocess the source content 210 for further analysis. For example, the source content 210 can be received from at least one tool of the set of content tools 130 described above with reference to FIG. 1. The source content 210 can include video data and/or audio data (e.g., audiovisual data). For example, the source content 210 can include at least one of: a recorded video (e.g., movie or television show), a live video (e.g., a live television show), streaming video, a non-streaming video, live or recorded audio recording (e.g., a song, podcast, interview), etc.

The preprocessing component 220 can include a number of subcomponents used to generate preprocessed content in response to receiving a request for content analysis (e.g., from an entity of the set of entities 110 of FIG. 1). For example, the preprocessing component 220 can receive the source content 210 (e.g., video and/or audio files, video and/or audio streams, image files, etc.) and use various preprocessing methods to facilitate subsequent processing of the source content 210.

The preprocessing component 220 can implement functionality to enhance useful visual feature and/or reduce undesirable visual artifacts in the source content 210, which can improve computer vision results during concept and/or moment detection (as will be described in further detail below). For example, as shown in FIG. 2B, the preprocessing component 220 can include at least one of a smoothing subcomponent 221 or a sharpening subcomponent 222. The smoothing component 221 can perform smoothing or de-noising, and the sharpening subcomponent 222 can perform sharpening or de-blurring. More specifically, the smoothing can be performed in the spatial and/or time domain, and the sharpening can be performed in the frequency domain.

To accelerate computer vision and/or to conserve computational resources such as cost and/or time based on motion present video of the source content 210, the preprocessing component 220 can detect video frame-based changes in video files, video streams, image files, and/or their numerical derivatives. For example, as shown in FIG. 2B, the preprocessing component can include at least one of an edge detection subcomponent 223, a scene detection subcomponent 224 or an image segmentation subcomponent 225.

The edge detection subcomponent 223 can perform edge detection to locate the boundaries of objects within an image. For example, the edge detection subcomponent 223 can detect brightness discontinuities. Illustratively, the edge detection subcomponent 223 can perform edge detection by calculating the partial gradient of frame pixel colors with respect to the spatial dimension.

The scene detection subcomponent 224 can perform scene detection to detect transitions between shots in a video using temporal segmentation. A shot is a temporal unit referring to a collection of consecutive images that represent a continuous action in space-time (e.g., uninterrupted filming). Illustratively, shot segmentation can be performed using a temporal 1D partitioning. Transitions exist between adjacent shots. A transition can be a hard or abrupt transition (“hard cut”), or a soft or gradual transition (e.g., “soft cut” or “fade”). Thus, scene detection can be analogously referred to as cut detection.

The image segmentation subcomponent 225 can perform image segmentation by partitioning an image into a number of image segments (e.g., image regions) each including a set of pixels. Illustratively, image segmentation can be performed using a spatial 2D partitioning. The purpose of image segmentation is to modify an image representation for simplified image analysis. Image segmentation can be performed by associating each pixel with a label, where pixels having the same label are pixels that share one or more similar characteristics (e.g., color, texture, intensity).

If there is insufficient meaningful motion depicted in a particular video segment, then some machine learning methods may be bypassed to perform concept and/or moment detection (e.g., object tracking). Accordingly, the preprocessing component 220 can reduce the processing time, cost, and resources required for implementing machine learning to perform concept and/or moment detection with respect to the source content 210.

The preprocessing component 220 can further implement functionality to process the source content 210 for natural language processing (NLP). For example, as shown in FIG. 2B, the preprocessing component 220 can further include an audio transcription subcomponent 226. The audio transcription subcomponent 226 can extract audio from the source content 210 and convert the audio into a text transcript using an audio transcription method. As will be described in further detail below, the text transcript can be analyzed using one or more NLP methods to identify a set of words within the text transcript.

The processing component 220 can further implement functionality to determine whether to continue analyzing the source content 210. For example, as shown in FIG. 2B, the preprocessing component 220 can further include a virality component 227. The virality component 227 can perform virality identification by implementing a virality algorithm to evaluate whether to continue analyzing the source content 210. If potential virality behavior is detected, then further analysis can be performed on the source content 210. Otherwise, such further analysis can be bypassed.

The virality algorithm can be implemented using a variety of suitable methods. One method for implementing the virality algorithm is by applying error-minimizing fitting to parametric families of curves that are generally considered to represent “viral” growth. Such curves can include, for example, exponential growth curves (with base strictly exceeding 1 and positive exponent), super-linear polynomial curves (with degree strictly exceeding 1), certain classes and/or subspaces of Non-Uniform Rational B-Splines (“NURBS”), etc.

Another method for implementing the virality algorithm is by generating a data structure using Bayesian machine learning of the source content's connectivity embedding. For example, the data structure can be a network graph.

Another method for implementing the virality algorithm is by employing an anomaly detection method. One example of an anomaly detection method is a neural network (e.g., recurrent neural network (RNN)) trained on non-viral video view data. This anomaly detection method can estimate the likelihood that an observation point comes from the RNN's training model, where a lower probability indicates more likely virality. Another example of an anomaly detection method is a neural network (e.g., RNN) trained on viral video view data. This anomaly detection method can estimate the likelihood that an observation point comes from the RNN's training model, where a lower probability indicates more likely non-virality.

Other methods for implementing the virality algorithm include, for example, implementing a variational autoencoder with long short-term memory (LSTM) to forecast a time series of video views, implementing (Hidden) Markov modeling of a video's view history with respect to time, implementing a random forest or gradient-boosted ensemble decision model with one or more of the preceding methods as decision trees, etc.

The preprocessing component 220 can further implement functionality to perform provider agnostic content identification. For example, as shown in FIG. 2B, the preprocessing component 220 can further include a content provider agnostic content identification (“provider agnostic”) subcomponent 228. The provider agnostic subcomponent 228 can perform provider agnostic identification of the source content 210 by uniquely identifying the source content 210 across potentially multiple providers the source content 210. For example, the provider agnostic subcomponent 228 can sample data from the source content 210 (e.g., video data (e.g., frames) and/or audio data), and create a unique logical content identifier (ID) (e.g., digital fingerprint), regardless of the content provider or resolution. Performing provider agnostic source identification can be used to prevent multiple copies of the same source content 210, provided by different content providers, from being analyzed by the system 200. For example, if the source content 210 includes sports content provided by a content provider A, but that same sports content provided by a content provider B was previously analyzed by the system 200, then provider agnostic subcomponent 228 can be used to prevent further analysis of the source content 210. Accordingly, the provider agnostic subcomponent 228 can enable reduced resource consumption within the system 200.

The preprocessed content can be received by the concept component 230. The concept component 230 can include a number of subcomponents used to identify concepts within the source content 210, and classify the concepts. For example, identifying concepts within the source content 210 can include decomposing the source content 210 into a number of units, and identifying a respective concept for each unit. A unit of source content refers to a minimum amount of data within the source content from which a meaning can be derived using one or more suitable machine learning techniques (e.g., computer vision, digital audio signal processing, semantic analysis). For example, a unit of source content can be a visual unit or an audio unit. A visual unit can be a frame including one or more objects, a sequence of frames depicting one or more actions, a minimum amount of text that conveys meaning (e.g., phrase, sentence, question), etc. An audio unit can be a minimum amount of audio (e.g., speech, sounds or words) that conveys meaning. For example, if a frame of source content includes an image of a dog, then the frame can be classified as at least one of “dog”, “animal”, etc. As another example, if characters within a scene are discussing taking a trip to Europe, then the audio can be classified as at least one of “travel”, “Europe”, etc. As yet another example, if there is a music in the content, then the music can be used to classify mood (e.g., happy, sad, scary). As yet another example, if there are birds “chirping” in the content, the audio can be used to identify at least one of “animal”, “bird”, etc.

Concepts can be identified and classified using artificial intelligence machine learning techniques. In some embodiments, and as shown in FIG. 2B, the concept component 230 can include at least one of an object recognition subcomponent 260, an action recognition subcomponent 270, a natural language processing (NLP) subcomponent 280, or a digital audio signal processing subcomponent 290.

The object recognition subcomponent 260 can perform object recognition to recognize or identify one or more objects based on at least a portion of the (preprocessed) source content. For example, the object recognition subcomponent 260 can receive, as input, the preprocessed source content derived from at least one of the smoothing subcomponent 221, the sharpening subcomponent 222, the edge detection subcomponent 223, the scene detection subcomponent 224 or the image segmentation subcomponent 225. The object recognition subcomponent 260 can perform object recognition using multi-label classification. For example, as shown in FIG. 2C, the object recognition subcomponent 260 can implement at least one of: person recognition 261 (e.g., celebrity recognition), face detection 262, emotion inference 263 (e.g., human emotion inference), label detection 264, product recognition 265, logo/brand recognition 266, text recognition (e.g., using optical character recognition (OCR)) 267, reality detection 268, or custom image recognition 269. Reality detection 268 can be used to detect whether a portion of the source content depicts real-life content or animated content (e.g., video game, cartoon). For example, there may be different criteria governing how to rate the safety of real-life content as compared to animated content.

The action recognition subcomponent 270 can perform action recognition to recognize or identify one or more actions (e.g., human actions) based on at least a portion of the (preprocessed) source content. For example, similar to the object recognition subcomponent 260, the action recognition subcomponent 270 can receive, as input, preprocessed source content derived from at least one of the smoothing subcomponent 221, the sharpening subcomponent 222, the edge detection subcomponent 223, the scene detection subcomponent 224 or the image segmentation subcomponent 225. The action recognition subcomponent 270 can perform action recognition using an optical flow method. Optical flow refers to a motion pattern observed with respect to a feature in a scene (e.g., object, surface, edge). An optical flow method can calculate motion between video frames each corresponding to a respective time step based on changes in space and/or time with respect to the video frames. For example, as shown in FIG. 2D, the action recognition subcomponent 270 can implement at least one of: pixel motion detection 271, edge motion detection 272, or spectrum detection 273.

Pixel motion detection 271 can detect pixel motion between video frames. Illustratively, pixel motion detection 271 can calculate the partial gradient of frame pixel colors with respect to the time dimension (in contrast to edge detection described above that can calculate the partial gradient of frame pixel colors with respect to the spatial dimension).

Edge motion detection 272 can detect edge motion between video frames. Illustratively, edge motion detection 272 can calculate the partial gradient of detected edges with respect to the time dimension (e.g., edges detected using the edge detection component 223).

Spectrum detection 273 can detect motion of meaningful objects within a video by reducing the likelihood of false-positive motion triggers. False-positive motion triggers can be caused by factors such as precipitation (e.g., rain, snow), motion of background elements (e.g., swaying branches, rustling leaves, bystanders), etc. Illustratively, spectrum detection 273 can calculate the partial gradient of a frame pixel color spectrogram with respect to time and/or frequency. A spectrogram generally refers to a visual representation of a spectrum of frequencies of a signal that varies as a function of time.

The NLP subcomponent 280 can perform NLP based on at least a portion of the (preprocessed) source content. For example, the NLP subcomponent 280 can receive, as input, preprocessed source content including the text transcript generated by the audio transcription subcomponent 226. The NLP subcomponent 280 can be used to identify a set of words within the text transcript. The set of words can include a set of keywords. The set of words can be used as supplemental data to assist with, for example, object recognition, training and testing of neural networks and machine learning models, and data management. For example, the NLP subcomponent 280 can implement at least one of: lexical analysis or tokenization, syntactic analysis or parsing, word embedding, sequence-to-sequence (S2S) learning, or bidirectional encoder representations from transformers (BERT).

The digital audio signal processing subcomponent 290 can perform digital audio signal processing based on at least a portion of the (preprocessed) source content to identify one or more characteristics of sound within audio content. To do so, the digital audio signal processing subcomponent 290 can decompose an audio signal into its constituent frequencies to obtain a spectrogram. For example, the digital audio signal processing subcomponent can utilize a Fourier transform method (e.g., discrete Fourier transform) to convert the audio signal from the time domain into the frequency domain.

In some embodiments, the digital audio signal processing subcomponent 290 detects moods or feelings based on music within respective portions of the source content 210. For example, the frequencies can be used to derive musical notes. A particular combination of musical notes in a sequence can define a musical key. The musical key can have a predefined association with a certain mood or feeling, such as happiness, anger, sadness, fear, funny, etc.

In some embodiments, the digital audio signal processing subcomponent 290 is used to perform audio classification. For example, the digital audio signal processing subcomponent 290 can use the spectrogram as an input for a trained neural network and linear classifier model for performing audio classification. Illustratively, the input can be a mel spectrogram, which is a spectrogram in which the frequencies are converted to the mel scale.

The concept component 230 can utilize a number of machine learning techniques to classify the concepts. For example, as shown in FIG. 2B, the concept component 230 can implement a set of machine learning methods 235 to perform the classification. The set of machine learning methods 235 can include at least one of: semantic mapping 291, context analysis 292, semantic similarity analysis 293, sentiment inference 294, association analysis 295, Bayesian belief network analysis 296, neural machine translation as applied to concept association (“neural machine translation”) 297, clustering analysis 298 (e.g., unsupervised clustering analysis), or Bayesian machine learning 299 (e.g., as applied to maximum likelihood classification). For example, the clustering analysis 298 can implement at least one of such as K-Means Clustering, Self-Organizing Map, K-Nearest Neighbors as applied to clustering, Principal Components Analysis, Independent Components Analysis, Fuzzy Clustering, Hierarchical Clustering, Gaussian Mixture Model Clustering, etc.

Referring back to FIG. 2A, the output of the concept component 230 (e.g., at least one categorized concept) can be provided to the moment component 240. The moment component 240 can be used to identify and/or evaluate (e.g., assess a value to) a set of moments detected from the concepts identified and classified by the concept component 230. Each moment can have a defined amount of time (e.g., number of seconds, time steps, etc.).

Each moment can refer to a segment of the source content defined by a respective grouping of concepts based on the classification. For example, as shown in FIG. 2E, the moment component 240 can include a segment grouping subcomponent 242. The segment grouping subcomponent 242 can utilize one or more clustering techniques, using the characteristics discovered in the content identification process as inputs, to generate logical segment groupings of the content in the source content 210. The one or more clustering techniques can include one or more hard clustering techniques in which each object belongs to a cluster or does not belong to cluster, and/or one or more soft or fuzzy clustering techniques in which each object belongs to each cluster to some extent (e.g., each object has a likelihood of belonging to a particular cluster). Examples of clustering techniques include Gaussian mixture models, centroid-based clustering (e.g., k-means clustering), density-based clustering, distribution-based clustering, etc.

Each moment can be categorized into one or more categories. For example, as shown in FIG. 2E, the moment component 240 can include at least one of: a genre categorization subcomponent 244 to perform genre categorization, an IAB categorization component 246 to perform IAB categorization or a GARM categorization component 248 to perform GARM categorization.

Moments identified and/or evaluated by the moment component 240 can be provided to the moment implementation component 250. The moment implementation component 250 can implement moments to perform one or more actions. For example, as shown in FIG. 2E, the moment implementation component 250 can include at least one of: a content cataloging subcomponent 251, a contextual sub-content targeting subcomponent 252, or a moment safety subcomponent 253.

The content cataloging subcomponent 251 can use moments to catalog content from a content library. For example, the content cataloging subcomponent 251 can catalog moments in view of their genre categorizations.

The contextual sub-content targeting subcomponent 252 can enable a number of different functions related to targeting contextual sub-content for particular moments (e.g., digital advertisements). Contextual sub-content refers to digital content that is identified as being relevant to a particular moment within a video. In some embodiments, contextual sub-content is digital advertising content that is identified for a particular moment within content, and can presented during consumption of the content. For example, if a moment within content is determined to have a “pet” categorization (e.g., the moment shows a dog), then contextual sub-content corresponding to a digital advertisement for pet food can be identified as being relevant to that moment.

For example, the contextual sub-content targeting subcomponent 252 can enable companion sub-content targeting 254. Companion sub-content targeting 254 can include companion digital advertisement targeting. The companion sub-content targeting 254 can marry traditional advertising formats (e.g., pre-roll, mid-roll, post-roll) with contextual sub-content integration, as will be described below.

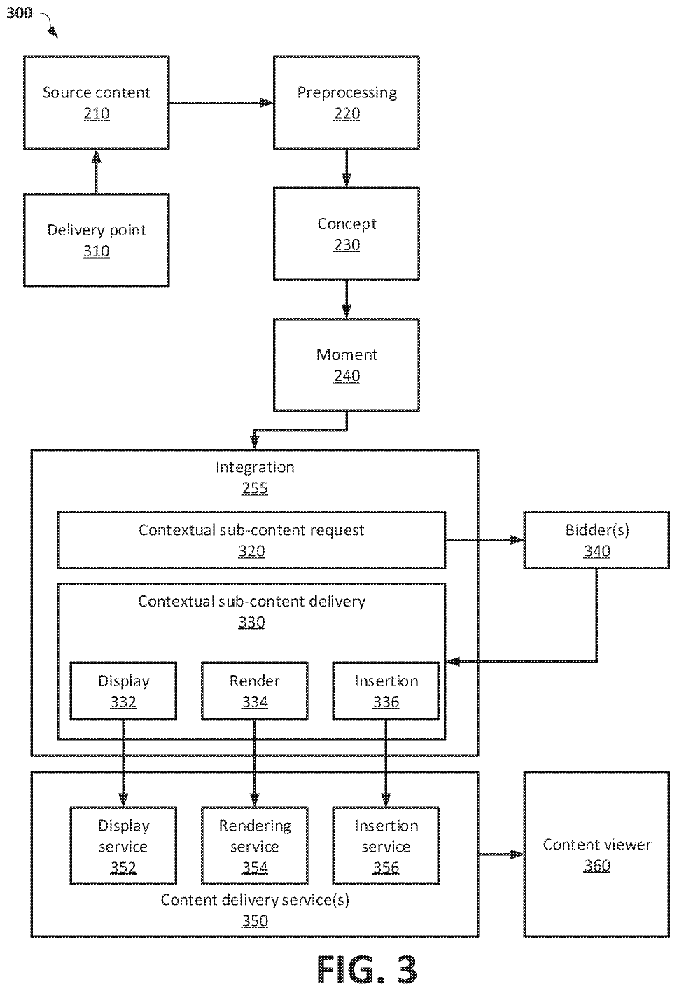

Additionally or alternatively, the contextual targeting subcomponent 252 can enable contextual sub-content integration (“integration”) 255. Performing the integration 255 can include at least one of: displaying contextual sub-content by overlaying the contextual sub-content over the content during content playback (e.g., on stream during video playback), rendering the contextual sub-content into the content (e.g., including the contextual sub-content within the content file itself), or inserting (e.g., stitching) the contextual sub-content into the content within the same stream (e.g., server side digital advertisement (“ad”) insertion (SSAI)). In some embodiments, the content can be streamed using a suitable streaming protocol (e.g., HTTP live streaming (“HLS”). For example, using moments, bid requests can be sent that target contextual aspects of content. Further details regarding performing the integration 255 are described in further detail below with reference to FIG. 3.

Additionally or alternatively, the contextual sub-content targeting subcomponent 252 can enable media syndication 256. Media syndication 256 refers to syndication of contextual sub-content by a third party entity. For example, if the third party entity is a job advertising website, and a construction company enlists the job advertising website to advertise a position for a construction foreman, the job advertising website (as a user of the system 200), can offer additional services to integrate a digital advertisement for the construction foreman position within a relevant moment in content (e.g., in a moment categorized as being related to construction).

Additionally or alternatively, the contextual sub-content targeting subcomponent 252 can enable media planning 257. Media planning 257 can use moments to search for contextual sub-content inventory that is most relevant (e.g., most relevant to a particular brand). For example, a media planner can micro-target specific segments of a video, understanding the amount available and spend needed to cover all targeted content.

Additionally or alternatively, the contextual sub-content targeting subcomponent 252 can enable data management 258. Data management 258 can use moments to collect and organize audience interest data within a data management platform (DMP) for audience targeting (e.g., targeted advertising campaigns). Data management 258 can be used to identify trends across content. Data management 258 can provide data analysis tools for performing research.

The moment safety subcomponent 253 can be used to identify moments within content that may be considered harmful (e.g., objectionable to audiences). Such moments can include adult content, violent content, political content, etc. Thus, such moments can be considered to be “off-limits” for contextual sub-content integration, at least for certain entities (e.g., brands). Thus, the moment safety subcomponent 253 can enable brand safety for brands who would like to integrate digital advertisements within content.

In some embodiments, the system 200 can implement a number of specialized neural networks and/or evolutionary algorithms (e.g., genetic algorithms, evolutionary programming algorithms, and/or swarm algorithms) that are tailored or targeted for one or more specific purposes, such as a particular recognition task (e.g., object recognition). Each specialized neural network can be referred to as a “Nano Neural Network” (NNN). Each NNN is individually trained and tested to perform a specialized machine learning task within the system (e.g., object recognition, action recognition). For example, one NNN can be trained as part of the object recognition subcomponent 260 to recognize a certain celebrity's face from various viewpoints or angles (e.g., face detection 242), another NNN can be trained as part of the object recognition subcomponent 260 to identify a certain brand of automobile (e.g., logo/brand recognition 246), etc. Each NNN can perform its specialized machine learning task in parallel using parallel processing to optimize processing resources (e.g., CPU and/or GPU resources).

Embodiments described herein can empirically optimize, on a continuous basis, the structural topology of NNN's in terms of a set of criteria. For example, the set of criteria can include task completion accuracy, task completion speed, etc. Embodiments described herein can use information derived from the source content to select, deploy and/or orchestrate the highest performing NNN's in accordance with their designated specialized machine learning tasks. Each NNN can be trained to learn its respective specialized machine learning task using training data relevant to the specialized machine learning task. Each NNN can be tested to validate the performance of the NNN using testing data. Testing data can be data that is relevant to the specialized machine learning task, but different from the training data. The testing can further generate performance metrics, such as specialized machine learning task accuracy percentage or rating, specialized machine learning task time or speed rating, number of compute cycles, structural complexity, etc.

FIG. 3 depicts a block/flow diagram of an example system 300 for implementing moments identified from source content, in accordance with some embodiments. More specifically, the system 300 illustrates the integration of contextual sub-content into content (e.g., integration 255 of FIG. 2E).

Similar to FIG. 2A, source content 210 is received by the preprocessing component 220 to generate preprocessed source content, the preprocessed source content is sent to the concept component 230 to classify a set of concepts identified from the preprocessed source content, and the set of concepts is sent to the moment component 240 to identify and/or evaluate a set of moments. The source content 210 can be received from a delivery point 310. In some embodiments, the delivery point 310 is a content viewer. In some embodiments, the delivery point 310 is a content management system (CMS) that manages content including the source content 210.

The set of moments can be provided to the integration subcomponent 255. As shown in FIG. 3, the integration subcomponent 255 can include a contextual sub-content request component 320 to generate a request related to contextual sub-content integration. The request can be sent with moment information. For example, the request can be an open real-time bidding (ORTB) request sent to one or more bidders 340, and at least one of the one or more bidders 340 can return an ORTB bid response. The bidders 340 can participate in an electronic auction to integrate contextual sub-content (e.g., digital advertisement) during one or more moments. For example, if a moment is categorized as being related to a pet (e.g., a person is walking a dog for a portion of video content), then a bidder associated with a pet company may want to integrate, into the video content at the time of the moment, a digital advertisement for one or more pet products sold by the pet company.

The integration subcomponent 255 can further include a contextual sub-content delivery component 330 that can initiate one or more actions to deliver the contextual sub-content. For example, the contextual sub-content delivery component 330 can initiate the one or more actions as defined by a selected ORTB bid response. The one or more actions can include a display action 332, a render action 334 and an insertion action 336. The display action 332 can be used to format the contextual sub-content for display over the content during the corresponding moment within the content (e.g., contextual sub-content overlay). The render action 334 can be used to format the contextual sub-content for rendering within the content during the corresponding moment within the content (e.g., including the contextual sub-content within the content file itself). The insertion action 336 can be used to format the contextual sub-content for insertion (e.g., stitching) within the content during the corresponding moment within the content (e.g., stitching the contextual sub-content within the same stream as the content).

The contextual sub-content delivery component 330 can interact with one or more content delivery services 350 to deliver the content with contextual sub-content integration to at least one content viewer 360 (e.g., at least one computing device). In some embodiments, the content viewer 360 is the delivery point 310. For example, the content delivery service(s) 350 can include at least one of a contextual sub-content display (“display”) service 352 to display the contextual sub-content with the content for viewing by the content viewer 360, a contextual sub-content rendering (“rendering”) service 354 to render the contextual sub-content within the content for viewing by the content viewer 360, or a contextual sub-content insertion (“insertion”) service 356 (e.g., SSAI) to insert the sub-content within the content for viewing by the content viewer 360.

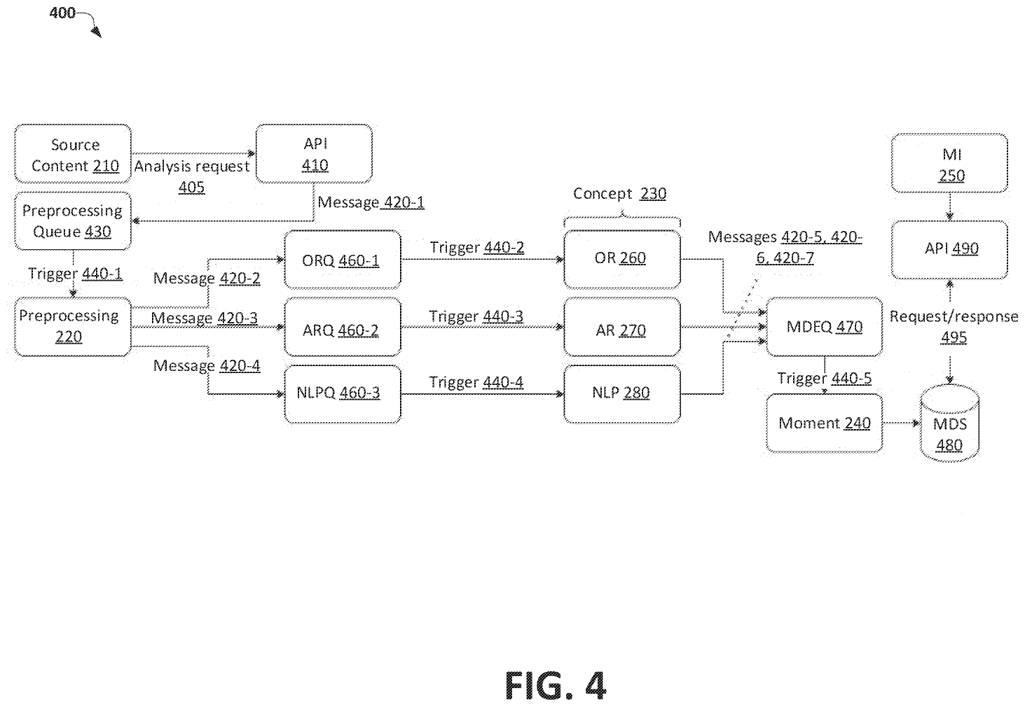

FIG. 4 depicts a block/flow diagram of a system architecture 400, in accordance with some embodiments. As shown, the system architecture 400 includes the source content 210. An analysis request 405 is received by an API 410 to initiate moment detection and evaluation. In response to receiving the analysis request 405, the API 410 can cause an event message (“message”) 420-1 to be sent to, and maintained by, a preprocessing queue 430. An event message is a data message that denotes an event which calls for a particular action (e.g., preprocess the source content). In some embodiments, a message can have an expiration time interval. An expiration time interval is a time period within which any requested output or portion thereof produced by the system 400 is valid. If an expiration time interval is not specified, then the expiration time interval can have a default value.

After receiving the message 420-1 (e.g., in response to receiving the message 420-1), the preprocessing queue 430 can generate an event trigger (“trigger”) 440-1, and send the trigger 440-1 to the preprocessing component 220 to trigger one or more preprocessing actions (e.g., one or more of smoothing, sharpening, edge detection, scene detection, image segmentation, audio transcription, virality identification, provider agnostic source identification).

The preprocessing component 220 can generate a number of messages, each of which being received by a respective concept identification message queue. For example, the messages can include an object recognition message 420-2 received by an object recognition queue (“ORQ”) 460-1, an action recognition message 420-3 received by an action recognition queue (“ARQ”) 460-2, and an NLP message 420-4 received by an NLP queue (“NLPQ”) 460-3. Although not shown in FIG. 4, the messages can further include a digital audio signal processing message, and the system 400 can further include a digital audio signal processing queue (DASPQ) to receive the digital audio signal processing message.

Each of the concept identification message queues can generate a respective trigger received by a respective subcomponent of the concept component 230. For example, after receiving the message 420-2 (e.g., in response to receiving the message 420-2), the ORQ 460-1 can generate a trigger 440-2, and send the trigger 440-2 to the object recognition (“OR”) subcomponent 260 to perform one or more object recognition actions (e.g., one or more of person recognition, face detection, emotion inference, label detection, product recognition, logo/brand recognition, text recognition, reality detection, or custom image recognition). After receiving the message 420-3 (e.g., in response to receiving the message 420-3), the ARQ 460-2 can generate a trigger 440-3, and send the trigger 440-3 to the action recognition (“AR”) subcomponent 270 to perform one or more action recognition actions (e.g., one or more of pixel motion detection, edge motion detection, or spectrum detection). After receiving the message 420-4 (e.g., in response to receiving the message 420-4), the NLPQ 460-3 can generate a trigger 440-4, and send the trigger 440-4 to the NLP subcomponent 280 to perform one or more NLP actions. Although not shown in FIG. 4, after receiving the message (e.g., in response to receiving the message), the DASPQ can generate a trigger, and send the trigger to the digital audio signal processing subcomponent 290 to perform one or more digital audio signal processing actions.

Each subcomponent of the concept component 230 can generate a respective message that is received by a moment detection and evaluation queue (MDEQ) 470. For example, the OR component subcomponent 260 can generate a message 420-5, the AR subcomponent 270 can generate a message 420-6 and the NLP subcomponent 280 can generate a message 420-7. Although not shown in FIG. 4, the digital audio signal processing subcomponent 290 can generate a message.

After receiving one or more of the messages from the concept component 230 (e.g., in response to receiving the one or more messages), the MDEQ 470 can generate a trigger 440-5, and send the trigger to the moment component 240 to detect and/or evaluate a set of moments. The set of moments can be maintained or stored in moment data storage (MDS) 480.

The moment implementation (MI) component 250 can obtain moments data from the MDS 480 for implementation. For example, the MI component 250 can perform at least one of: content cataloging, contextual sub-content targeting (e.g., companion sub-content targeting, integration, media syndication, media planning, data management), or moment safety (e.g., brand safety). To do so, the MI component 250 can interact with a moments data API 490 to establish communication with the MDS 480. For example, the API 490 can send a request for moments data to the MDS 480, and the MDS 480 can return a response with moments data identified in accordance with the request.

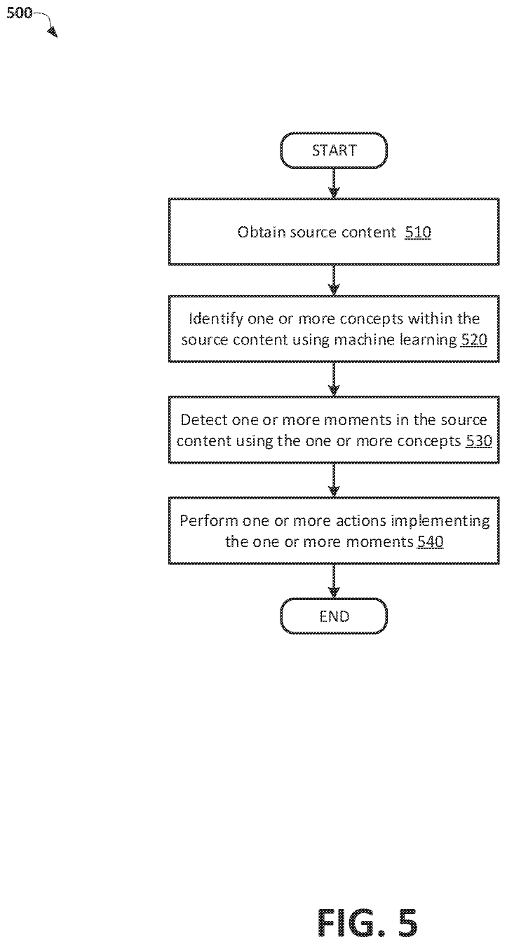

FIG. 5 depicts a flow diagram of an example method 500 for implementing moments identified from source content, in accordance with some embodiments. Method 500 may be performed by one or more processing devices that may comprise hardware (e.g., circuitry, dedicated logic, programmable logic, microcode, etc.), executable code (such as is run on a general purpose computer system or a dedicated machine), or a combination of both. For example, the one or more processing devices can perform individual functions, routines, subroutines, or operations to implement the method 500.

At block 510, processing logic obtains source content. The source content can be visual content and/or audio content (e.g., audiovisual content). For example, the source content can be video content. The source content can be recorded content, live content, streaming content, etc. Further details regarding the source content are described above with reference to FIG. 2.

At block 520, processing logic identifies one or more concepts within the source content using machine learning. For example, the source content can be decomposed into a number of units (e.g., frames, audio units), and one or more concepts can be identified for each unit of the source content. Identifying the one or more concepts can include performing at least one of: object recognition, action recognition or NLP. Examples of techniques used to perform object recognition include person recognition, face detection, (human) emotion inference, label detection, product recognition, logo/brand recognition, text recognition, reality detection, custom image recognition, etc. Examples of techniques used to perform action detection include pixel motion detection, edge motion detection and spectrum detection. Examples of techniques used to perform NLP include lexical analysis or tokenization, syntactic analysis or parsing, word embedding, sequence-to-sequence (S2S) learning, or bidirectional encoder representations from transformers (BERT), etc. In some embodiments, identify the one or more concepts includes preprocessing the source content to obtain preprocessed source content, and identifying the one or more concepts from the preprocessed source content. Preprocessing the source content can include performing at least one of: smoothing, sharpening, edge detection, scene detection, image segmentation, audio transcription, virality identification, provider agnostic source identification, etc. Identifying the one or more concepts can further include classifying each of the one or more concepts. Examples of techniques that can be used to classify concepts include semantic mapping, context analysis, semantic similarity analysis, sentiment inference, association analysis, Bayesian belief networks, neural machine translation, clustering analysis, Bayesian machine learning, etc. Further details regarding identifying and classifying concepts are described above with reference to FIG. 2.

At block 530, processing logic detects one or more moments in the source content using the one or more concepts. Each moment can be a segment defining a grouping of concepts. The moment can have an associated length of time within the content (e.g., number of seconds, time stamps). Detecting the one or more moments can further include categorizing each moment into one or more categories. For example, categorizing each moment can include performing at least one of: genre categorization to assign a genre categorization to the moment, JAB categorization to assign an JAB categorization to the moment, or GARM categorization to assign a GARM category to the moment. Further details regarding detecting and categorizing moments are described above with reference to FIG. 2.

At block 540, processing logic performs one or more actions implementing the one or more moments. For example, the one or more actions can include at least one of: content cataloging, contextual sub-content targeting or moment safety. Examples of contextual sub-content target can include contextual sub-content integration, companion sub-content targeting, media syndication, media planning, data management, etc. Further details regarding performing actions implementing moments are described above with reference to FIG. 2.

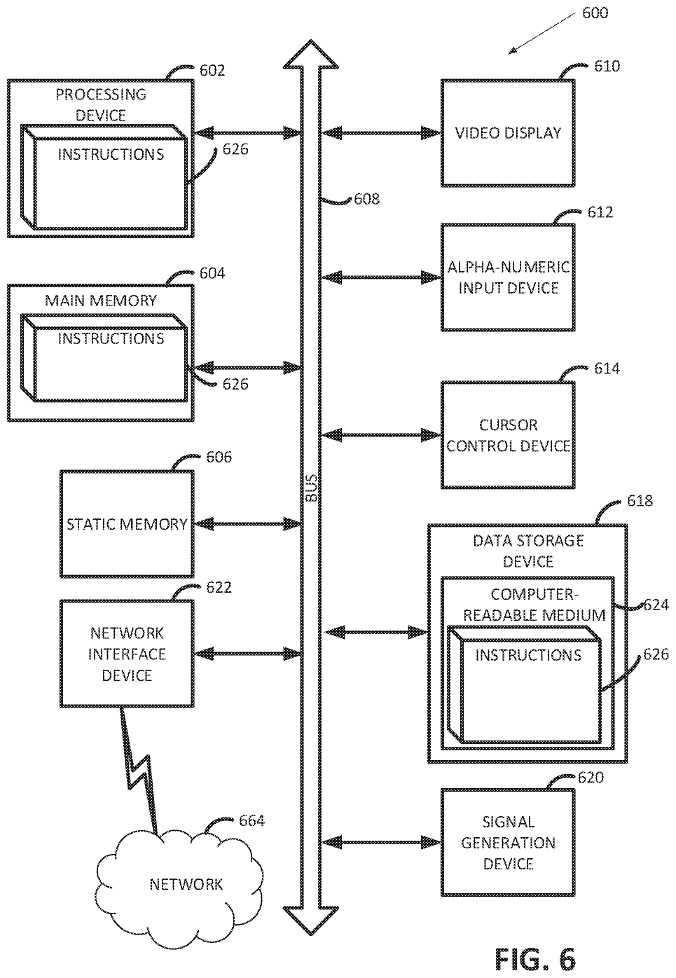

FIG. 6 depicts a block diagram of a computer system operating in accordance with one or more aspects of the disclosure. In various illustrative examples, computer system 600 may correspond to one or more components of the system 100 of FIG. 1 and/or the system 200 of FIG. 2. The computer system may be included within a data center that supports virtualization. Virtualization within a data center results in a physical system being virtualized using virtual machines to consolidate the data center infrastructure and increase operational efficiencies. A virtual machine (VM) may be a program-based emulation of computer hardware. For example, the VM may operate based on computer architecture and functions of computer hardware resources associated with hard disks or other such memory. The VM may emulate a physical computing environment, but requests for a hard disk or memory may be managed by a virtualization layer of a computing device to translate these requests to the underlying physical computing hardware resources. This type of virtualization results in multiple VMs sharing physical resources.

In certain implementations, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., random access memory (RAM)), a non-volatile memory 606 (e.g., read-only memory (ROM) or electrically-erasable programmable ROM (EEPROM)), and a data storage device 616, which may communicate with each other via a bus 608.

Processing device 602 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 600 may further include a network interface device 622. Computer system 600 also may include a video display unit 610 (e.g., an LCD), an alphanumeric input device 612 (e.g., a keyboard), a cursor control device 614 (e.g., a mouse), and a signal generation device 620. Data storage device 616 may include a non-transitory computer-readable storage medium 624 on which may store instructions 626 encoding any one or more of the methods or functions described herein, including instructions for implementing the system 200. Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

Other computer system designs and configurations may also be suitable to implement the system and methods described herein. The following examples illustrate various implementations in accordance with one or more aspects of the present disclosure.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner. In certain implementations, not all operations or sub-operations of the methods herein are required to be performed.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that aspects of the present disclosure may be practiced without these specific details. In some instances, well-known structures and devices are shown in block diagram form, rather than in detail, in order to avoid obscuring the present disclosure.

Unless specifically stated otherwise, as apparent from the following discussion, it is appreciated that throughout the description, discussions utilizing terms such as “obtaining,” “preprocessing,” “identifying,” “detecting,” “implementing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the specific purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Aspects of the disclosure presented herein are not inherently related to any particular computer or other apparatus. Various general purpose systems may be used with programs in accordance with the teachings herein, or it may prove convenient to construct more specialized apparatus to perform the specified method steps. The structure for a variety of these systems will appear as set forth in the description below. In addition, aspects of the present disclosure are not described with reference to any particular programming language. It will be appreciated that a variety of programming languages may be used to implement the teachings of the disclosure as described herein.

Aspects of the present disclosure may be provided as a computer program product that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not have an ordinal meaning according to their numerical designation.

What is claimed is:

1. A method comprising:
obtaining, by a processing device, source content, wherein the source content comprises at least one of visual content or audio content;
preprocessing, by the processing device, the source content to obtain preprocessed source content;
identifying, by the processing device using machine learning, a set of concepts based on the preprocessed source content, wherein each concept of the set of concepts is identified for a respective unit of the source content; and
detecting, by the processing device, a set of moments in the source content, wherein each moment of the set of moments corresponds to a respective grouping of concepts of the set of concepts, wherein each moment of the set of moments is associated with one or more attributes that describe the moment within the source content, and wherein each moment of the set of moments is associated with one or more categories.

2. The method of claim 1, wherein preprocessing the source content comprises performing at least one of: smoothing, sharpening, edge detection, scene detection, image segmentation, audio transcription, virality identification, or provider agnostic content identification.

3. The method of claim 1, wherein identifying the at least one moment comprising performing at least one of: object recognition, action recognition, natural language processing, or digital signal processing.

4. The method of claim 1, wherein identifying the set of concepts comprises implementing a plurality of specialized neural networks, wherein each specialized neural network of the plurality of specialized neural networks is trained for a particular machine learning task.

5. The method of claim 1, further comprising implementing, by the processing device, the set of moments to perform one or more actions.

6. The method of claim 5, wherein the one or more actions comprise at least one of: content cataloging, contextual sub-content targeting, or moment safety.

7. The method of claim 6, wherein the contextual sub-content targeting comprises at least one of: companion sub-content targeting, contextual sub-content integration, media syndication, media planning, or data management.

8. A system comprising:
a memory device; and
a processing device, operatively coupled to the memory device, to perform operations comprising:
obtaining source content, wherein the source content comprises at least one of visual content or audio content;
preprocessing the source content to obtain preprocessed source content;
identifying, using machine learning, a set of concepts based on the preprocessed source content, wherein each concept of the set of concepts is identified for a respective unit of the source content; and
detecting a set of moments in the source content, wherein each moment of the set of moments corresponds to a respective grouping of concepts of the set of concepts, wherein each moment of the set of moments is associated with one or more attributes that describe the moment within the source content, and wherein each moment of the set of moments is associated with one or more categories.

9. The system of claim 8, wherein preprocessing the source content comprises performing at least one of: smoothing, sharpening, edge detection, scene detection, image segmentation, audio transcription, virality identification, or provider agnostic content identification.

10. The system of claim 8, wherein identifying the at least one moment comprising performing at least one of: object recognition, action recognition, natural language processing, or digital signal processing.

11. The system of claim 8, wherein identifying the set of concepts comprises implementing a plurality of specialized neural networks, wherein each specialized neural network of the plurality of specialized neural networks is trained for a particular machine learning task.

12. The system of claim 9, wherein the operations further comprise implementing the set of moments to perform one or more actions.

13. The system of claim 12, wherein the one or more actions comprise at least one of: content cataloging, contextual sub-content targeting, or moment safety.

14. The system of claim 13, wherein the contextual sub-content targeting comprises at least one of: companion sub-content targeting, contextual sub-content integration, media syndication, media planning, or data management.

15. A non-transitory computer-readable storage medium comprising instructions that, when executed by a processing device, cause the processing device to perform operations comprising:
obtaining source content, wherein the source content comprises at least one of visual content or audio content;
preprocessing the source content to obtain preprocessed source content;
identifying, using machine learning, a set of concepts based on the preprocessed source content, wherein each concept of the set of concepts is identified for a respective unit of the source content; and
detecting a set of moments in the source content, wherein each moment of the set of moments corresponds to a respective grouping of concepts of the set of concepts, wherein each moment of the set of moments is associated with one or more attributes that describe the moment within the source content, and wherein each moment of the set of moments is associated with one or more categories.

16. The non-transitory computer-readable storage medium of claim 15, wherein preprocessing the source content comprises performing at least one of: smoothing, sharpening, edge detection, scene detection, image segmentation, audio transcription, virality identification, or provider agnostic content identification.

17. The non-transitory computer-readable storage medium of claim 15, wherein identifying the at least one moment comprising performing at least one of: object recognition, action recognition, natural language processing, or digital signal processing.

18. The non-transitory computer-readable storage medium of claim 15, wherein identifying the set of concepts comprises implementing a plurality of specialized neural networks, wherein each specialized neural network of the plurality of specialized neural networks is trained for a particular machine learning task.

19. The non-transitory computer-readable storage medium of claim 15, wherein the operations further comprise implementing the set of moments to perform one or more actions, and wherein the one or more actions comprise at least one of: content cataloging, contextual sub-content targeting, or moment safety.

20. The non-transitory computer-readable storage medium of claim 19, wherein the contextual sub-content targeting comprises at least one of: companion sub-content targeting, contextual sub-content integration, media syndication, media planning, or data management.
